(19) United States
(12) Patent Application Publication
(10) Pub. No.: US 2010/0060922 A1
(43) Pub. Date: Mar. 11, 2010

(54) IMAGE FORMING APPARATUS AND CONTROLLING METHOD FOR THE SAME

(75) Inventor: Masahide Teranoshita, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/556,021

(22) Filed: Sep. 9, 2009

Related U.S. Application Data
(60) Provisional application No. 61/095,492, filed on Sep. 9, 2008.

(51) Int. Cl. G06F 3/12

(52) U.S. Cl. 358/1.13

(57) ABSTRACT

A MFP stores document type information and a contact destination of an approver in association with each other. When the MFP receives a job execution request from a communication apparatus, the MFP transmits an approval request for output of an electronic document to the contact destination. When the output of the electronic document is approved, the MFP executes any one job among printing, mail transfer, web publication, and facsimile transmission.

### CROSS-REFERENCE TO RELATED APPLICATION

The present application claims priority under 35 U.S.C. 119 to U.S. Provisional Application Ser. No. 61/095,492, entitled PRINT ADMISSION SYSTEM, to Teranoshita, filed on Sep. 9, 2008, the entire disclosure of which is incorporated herein by reference.

### TECHNICAL FIELD

The present invention relates to an image forming apparatus and a controlling method for the image forming apparatus.

### BACKGROUND

A MFP (Multi Function Peripheral) has functions of printing, scanning, copying, mail (email) transmission and reception, web (World Wide Web) browsing, and facsimile communication.

An organization restricts printing and distribution of material in an electronic data format. To print the material in the electronic data format with the MFP, originally, an approval by an approver who approves the printing is necessary.

An image forming apparatus disclosed in JP-A-2008-194942 starts print processing for print data stored in a storage device when print approver approval means permits approval.

An image formation managing apparatus disclosed in JP-A-2005-202669 stores a condition for restriction of image formation and transmits a mail to an approver who can approve release of the restriction.

JP-A-2006-140622 discloses that a MFP transmits an approval confirmation notification mail to an approver electronic mail address.

JP-A-2005-250970 discloses that a MFP transmits notification for confirming output approval for electronic data to a user PC (personal computer) of an approver.

A print control apparatus disclosed in JP-A-2008-140111 generates, when a specific kind of image data is included in a print job, information for checking whether execution of the print job should be approved and transmits the information to an approver.

JP-A-2008-12715 discloses that a printer transmits a preview to an administrator PC and that the administrator PC inspects the preview and instructs the printer whether output approval is possible.

However, when a terminal of a user who does not have an authority for printing can give an instruction for output of material to a MFP, the MFP carries out output of all kinds of material in the electronic data format.

The output of the material indicates that, for example, the material is printed on a medium, the material is transferred by mail, the material is published on a web site, and the material is transmitted by facsimile.

In the related arts explained above, when an authority for output is given to a specific terminal, material restricted from being distributed and printed is output without approval of an approver.

Control for giving an output authority to a user terminal means control for permitting the terminal to output material. However, the control does not include approval of the output of the material.

In some case, a draft not yet permitted to be published is present in a large number of pieces of material. The draft needs to be approved to be published by an approver.

When an authority for output of material is given to a specific terminal, the specific terminal can output material that should be approved. For example, it is possible that material that needs to be approved by plural people before being published, confidential material, and material including personal information are output from the specific terminal.

It is difficult for a person to find an approver for information output before outputting information such as material. It is difficult for a terminal to determine whether plural kinds of material may be output.

### SUMMARY

It is an object of the present invention to provide an image forming apparatus that performs, when material of an electronic data format is, for example, printed, transferred by mail, stored in a web server, and transmitted by facsimile, approval processing for material prior to information output such as printing and determines whether the material is information for which printing and the like may be executed.

In an aspect of the present invention, an image forming apparatus includes: a job managing unit configured to manage queues of a job of an image forming unit for printing an image on a medium, a job for transmitting data including image data by mail, a job for distributing the image data through the Internet, and a job for transmitting the image data using a facsimile apparatus; an interface unit configured to receive, from a communication apparatus connected to a network, a job execution request including an electronic document that should be approved and a job type of any one of the jobs executed on the electronic document; a storing unit configured to store document type information for identifying a type of the electronic document received by the interface unit and a contact destination of an approver for the electronic document in association with each other; an approval managing unit configured to transmit an approval request for output of the electronic document to the contact destination stored by the storing unit and receive a determination result concerning possibility of output responding to the approval request; and a control unit configured to cause, when the determination result received by the approval managing unit is affirmative, the job managing unit to execute the job of the job execution request received by the interface unit.

### DESCRIPTION OF THE DRAWINGS

FIG. 1 is a diagram of an image forming apparatus according to an embodiment of the present invention;

FIG. 2 is a diagram of a MFP;

FIG. 3 is a block diagram of a facsimile transmitting and receiving apparatus;

FIG. 4 is a hardware block diagram of a control system for the MFP;

FIG. 5 is a functional block diagram of the control system for the MFP;

FIG. 6 is a flowchart for explaining a controlling method for the MFP;

FIGS. 7A to 7C are diagrams of examples of a dialog box;

FIG. 8 is a diagram of data structure of an approval information table;

FIGS. 9A and 9B are diagrams of examples of job management tables;

FIG. 10 is a diagram of an example of an approval request screen of a display of an approver terminal;

FIG. 11 is a diagram of a collaboration process of three components and a processing flow;

FIG. 12A is a diagram of a situation in which plural users request the MFP to output material; and

FIG. 12B is a diagram of a situation in which the MFP approves or rejects the output request.

### DETAILED DESCRIPTION

Throughout this description, the embodiments and examples shown should be considered as exemplars, rather than limitations on the apparatus and methods of the present invention.

An image forming apparatus and a controlling method for the image forming apparatus are explained in detail below with reference to the accompanying drawings. In the drawings, the same components are denoted by the same reference numerals and signs. Redundant explanation of the components is omitted.

### Overview

An image forming apparatus according to an embodiment of the present invention is a MFP. The MFP has an information output function. The MFP performs printing of material on paper, mail transfer of the material, storage of the material in a web server, and facsimile transmission of the material.

The material indicates an electronic document restricted from being printed and distributed. The material is, for example, attainment, results, and achievements yielded at a design stage.

A controlling method for an image forming apparatus according to this embodiment is a method with which the MFP approves the following (a) to (d): (a) printing of a material on paper; (b) transfer of the material to a terminal by mail; (c) storage of the material in a PDF file format; and (d) transmission of the material by facsimile.

In the controlling method, when the MFP receives a command for output of material from a user terminal, the MFP causes an approver terminal to approve the material.

The user terminal is a terminal for a person who does not have an approval authority for output of the material. The approver terminal is a terminal for an approver who has the approval authority, for example, an organization head or a leader.

In the controlling method, prior to approval processing, the MFP writes in advance a correspondence relation between material type information of the material and contact destination information of the approver terminal in an internal memory. The material type indicates information for classification defined and given by a person in advance according to rules and the like determined by an organization.

The organization has rules concerning distribution and printing of documents. The material is distributed and printed under the rules. The rules restrict material with a name such as “design specifications.doc”, “schedule table.xls”, and “progress management table.xls” from being distributed and printed.

In the controlling method, when the material is not approved by the approver terminal, the MFP does not permit the material to be printed. When the material is not approved by the approver terminal, the MFP does not permit the material to be transmitted to other terminals by mail, published on a web server, and transmitted by facsimile.

An application program of the user terminal that commands the output of the material attaches material type information to the material transmitted to the MFP.

When the MFP receives the command for printing or the like of the material from the user terminal, the MFP spools a job and reads out the material type information of the received material. The MFP retrieves the material type information into an internal memory and requests the approver terminal to approve the received material.

When approval is notified from the approver terminal, the MFP executes the spooled job. When rejection is notified from the approver terminal, the MFP discards the spooled job.

### Overall Configuration

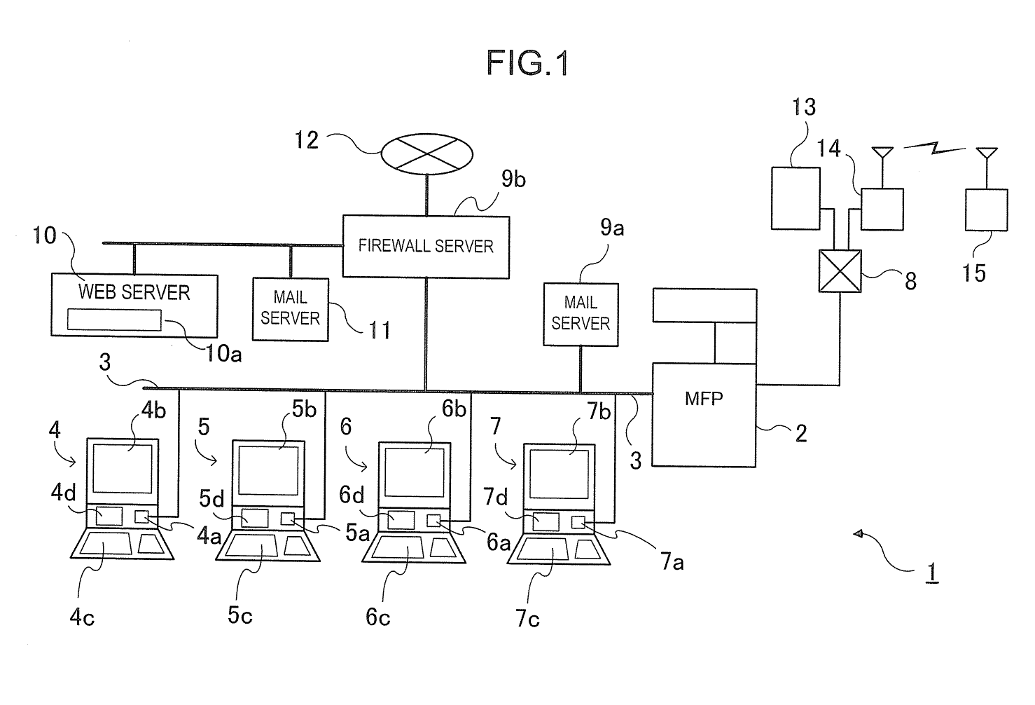

FIG. 1 is a diagram of a system including a MFP. A system 1 has a function of approving information to be output in an organization.

The system 1 includes a MFP 2, a LAN (Local Area Network) 3, approver terminals 4 and 5, user terminals 6 and 7 (communication apparatuses), and a public line 8. Both the user terminals 6 and 7 are communication apparatuses connected to a network.

The MFP 2 has functions of printing, scanning, coping, mail transmission and reception, web browsing, and facsimile communication.

The MFP 2 creates image data from PDL (page description language) data of material transmitted by the approver terminals 4 and 5 and user terminals 6 and 7 and print-outputs the image data.

The LAN 3 is a network. A mail server 9a for an internal client and a firewall server 9b are connected to the LAN 3.

A web server 10 for information provision, a mail server 11 for an external client, and the Internet 12 are connected to the firewall server 9b.

Mail software for smtp (simple sail transfer protocol) and pop3 (post office protocol 3) is implemented in the mail servers 9a and 11.

The MFP 2 transmits and receives a mail to and from the approver terminals 4 and 5 and the user terminals 6 and 7 via the mail server 9a. The MFP 2 transmits and receives a mail to and from a not-shown external mail server via the mail server 11.

The web server 10 receives a PDF file to be published on a web from the user terminals 6 and 7. When the PDF file is stored in the web server 10, a web page creation program 10a implemented in the web server 10 creates a web page including the PDF file.

The MFP 2 transmits facsimile data to a facsimile terminal 13 via the public line 8. The MFP 2 transmits a message to a cellular phone 15 via a base station 14. The cellular phone 15 can also function as an approver terminal.

All of the approver terminals 4 and 5 and the user terminals 6 and 7 are personal computers. The approver terminals 4 and 5 are used by people having an approval authority. The user terminals 6 and 7 are used by people not having the approval authority.

The approver terminal 4 includes a network interface 4a, a display 4b, an input device 4c, and a storage device 4d. The input device 4c is a keyboard, a mouse, or the like. The storage device 4d is a hard disk drive or an extended memory device.

The approver terminal 5 includes a network interface 5a, a display 5b, an input device 5c, and a storage device 5d.

The user terminal 6 includes a network interface 6a, a display 6b, an input device 6c, and a storage device 6d. The user terminal 7 includes a network interface 7a, a display 7b, an input device 7c, and a storage device 7d.

The network interfaces 5a, 6a, and 7a are substantially the same as the network interface 4a. The displays 5b, 6b, and 7b are substantially the same as the display 4b. The input devices 5c, 6c, and 7c are substantially the same as the input device 4c. The storage devices 5d, 6d, and 7d are substantially the same as the storage device 4d.

Material stored by the storage devices 6d and 7d belongs to a material type restricted from being printed and distributed.

An application program or a printer driver stored in the storage devices 6d and 7d gives material type information to the material when the material is transmitted to the MFP 2.

The user terminals 6 and 7 inquire the MFP 2 about the material type information and acquire the material type information from the MFP 2. The MFP 2 stores correspondence between the material and the material type information.

As an example, the material type information is level values of levels represented by five stages. A level 4 indicates confidential, a level 0 indicates publication, and levels 3 to 1 indicate keeping confidential from outsiders.

As plural levels, levels of information assets determined by an organization to evaluate whether an ISMS (Information Security Management System) of the organization conforms to an international standard are used. The MFP 2 registers a correspondence relation in advance according to the operation by an organization head.

The storage devices 6d and 7d store personal information of a customer. When the user terminals 6 and 7 transmit, for example, a material name “personal information” to the MFP 2, the MFP 2 returns material type information “level 4”.

When material is transmitted from the user terminals 6 and 7 to the MFP 2, the MFP 2 extracts a level value of a material type. The MFP 2 refers to an internal memory in which a contact destination of an approver is stored and notifies an approver terminal corresponding to the level value of an approval request.

For example, the MFP 2 requests the approver terminals 4 and 5 to approve material. The cellular phone 15 may be included in terminals that should approve material. Any one of the terminals that should approve material receives the approval request transmitted from the MFP 2. The terminal that should approve material transmits approval or rejection to the MFP 2 as a reply via the operation by a person.

The MFP 2 executes, in response to a request for output of a material, a job only when the MFP 2 receives the reply of approval from the terminal that should approve material. The MFP 2 controls the approval of the output of the material. The system 1 manages security of information.

### Configuration of the MFP 2

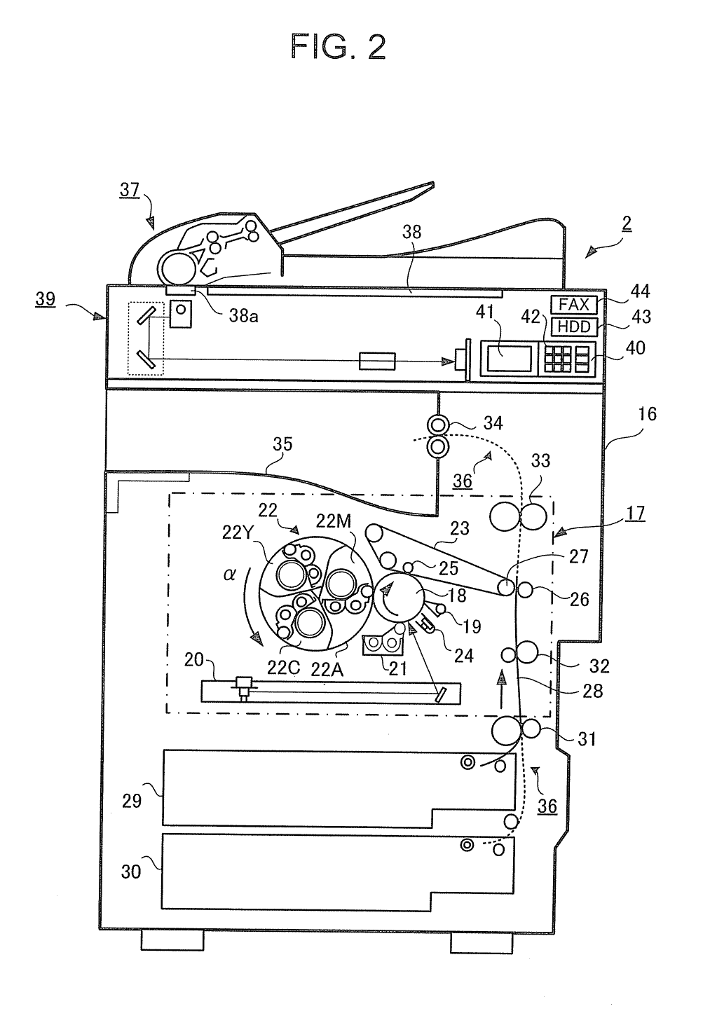

FIG. 2 is a diagram of the MFP 2. Reference numerals and signs same as those described above represent the same components.

A printer unit 17 (an image forming unit) is provided in a middle section of a housing 16 of the MFP 2. The printer unit 17 includes a photoconductive drum 18.

A charging device 19, an exposing device 20, a monochrome developing device 21, a color developing device 22, a belt 23, and a cleaning device 24 are provided around the photoconductive drum 18.

The charging device 19 charges a photoconductive member of the photoconductive drum 18.

The exposing device 20 irradiates a laser beam on the photoconductive drum 18. Light intensity of the laser beam is modulated according to information of an image that should be printed.

The monochrome developing device 21 develops an electrostatic image formed on the photoconductive drum 18 with a monochrome toner. The color developing device 22 develops the electrostatic image formed on the photoconductive drum 18 with toners of three colors.

The color developing device 22 includes a revolver 22A that rotates around a revolver shaft and developing units 22Y, 22C, and 22M of Y (yellow), C (cyan), and M (magenta) provided in the revolver 22A.

The developing units 22Y, 22C, and 22M include developing devices and toner cartridges, respectively. The developing units 22Y, 22C, and 22M are radially provided on an outer side of an outer circumferential surface of the revolver shaft and along a radial direction of the shaft.

The developing units 22Y, 22C, and 22M are rotated in an arrow α direction in order to be located in a developing position opposed to an outer circumferential surface of the photoconductive drum 18 according to a request for image output.

When an image to be printed is color, electrostatic images of the respective colors formed on the photoconductive drum 18 are developed by the developing units 22Y, 22C, and 22M.

The belt 23 is a belt for intermediate transfer. Tension is applied to the belt 23 by plural rollers. When any one of the rollers drives to rotate the belt 23, the belt 23 endlessly travels.

When the belt 23 travels, toner images of the four colors are transferred onto an outer circumferential surface of the belt 23. An intermediate transfer roller 25 for applying transfer voltage is provided on an inner circumferential surface side of the belt 23. The intermediate transfer roller 25 can come into contact with and separate from the photoconductive member.

A transfer roller 26 for secondary transfer is provided in a direction in which the toner images of the four colors on the belt 23 are carried. The transfer roller 26 transfers the toner images on the belt 23 onto a sheet 28 in conjunction with a counter roller 27.

Cassettes 29 and 30 that store bundles of sheets 28 are provided in a lower section of the housing 16 of the MFP 2. One sheet 28 in the cassettes 29 and 30 is conveyed upward by conveying rollers 31, registration rollers 32, and fixing rollers 33. Paper discharge rollers 34 discharge the conveyed sheet 28 to a tray 35.

A sequence of outlets of the cassettes 29 and 30, the conveying rollers 31, the registration rollers 32, the transfer roller 26, the fixing rollers 33, the paper discharge rollers 34, and an inlet of the tray 35 defines a conveying path 36 for the sheet 28.

An ADF (Automatic Document Feeder) 37 is provided in an upper section of the housing 16 of the MFP 2. The ADF 37 is located to be opened or closed with respect to a document table 38. A scanner 39 reads an original document via a window 38a for reading a sheet surface. The scanner 39 collects reflected light from the original document and generates luminance information of lights of the respective colors.

An operation panel 40 is attached to the housing 16 of the MFP 2. The operation panel 40 includes a touch screen 41, hardware buttons 42, and a not-shown driver circuit.

When a person touches the touch screen 41, information such as mail addresses of the approver terminals 4 and 5 and a material type of material is set in the MFP 2.

During image formation, the exposing device 20 modulates a laser beam according to information read by the scanner 39 and outputs the laser beam. The laser beam is irradiated on the surface of the photoconductive drum 18. A latent image corresponding to the intensity of the laser beam is formed on the photoconductive drum 18.

The monochrome developing device 21 and the color developing device 22 supply toners, respectively. The latent image on the photoconductive drum 18 is visualized as toner images.

When the photoconductive drum 18 rotates, the toner images on the photoconductive drum 18 are carried to an intermediate transfer position. The toner images are transferred onto the belt 23 by bias voltage applied from the intermediate transfer roller 25.

The toner images on the belt 23 are carried to a transfer area opposed to the transfer roller 26 according to the movement of the belt 23 and transferred onto the sheet 28 fed to the transfer area. Bias voltage is supplied from the transfer roller 26 to the sheet 28.

The sheet 28 having the toner images transferred thereon is guided to a fixing device having the fixing rollers 33. The fixing device supplies heat to the sheet 28 and fixes the toner images on the sheet 28. The conveying rollers 31 hold the sheet 28 having the images fixed thereon and convey the sheet 28 to the tray 35.

A configuration of the printer unit 17 is not limited to the example shown in the figure. The printer unit 17 can be attained by various configurations.

Further, a hard disk driver (HDD) 43 and a facsimile transmitting and receiving apparatus 44 (a facsimile apparatus) are provided in the housing 16 of the MFP 2.

The hard disk drive 43 stores an OS (operating system), application programs and utility programs, and temporary data such as received data and work data.

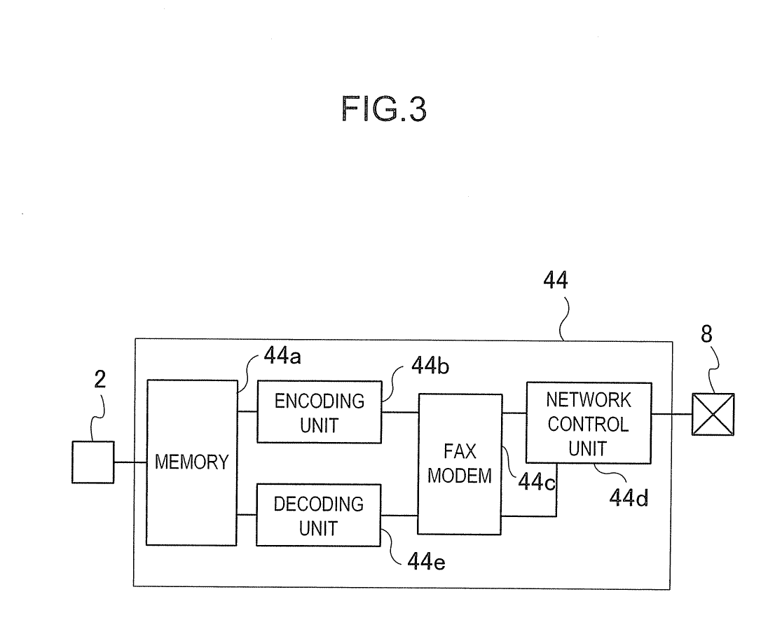

FIG. 3 is a block diagram of the facsimile transmitting and receiving apparatus 44. Reference numerals and signs same as those described above represent the same components. The facsimile transmitting and receiving apparatus 44 includes a memory 44a, an encoding unit 44b, a facsimile modem 44c, a network control unit 44d, and a decoding unit 44e.

The encoding unit 44b encodes and compresses image data in the memory 44a. The facsimile modem 44c modulates the encoded image data and converts the image data into a facsimile signal. The facsimile modem 44c demodulates a received facsimile signal and outputs image data.

The network control unit 44d controls call connection between the facsimile transmitting and receiving apparatus 44 and the public line 8. The decoding unit 44e decodes the image data from the facsimile modem 44c and expands the decoded data. The decoding unit 44e writes the data obtained in this way in the memory 44a.

### Control System for the MFP 2

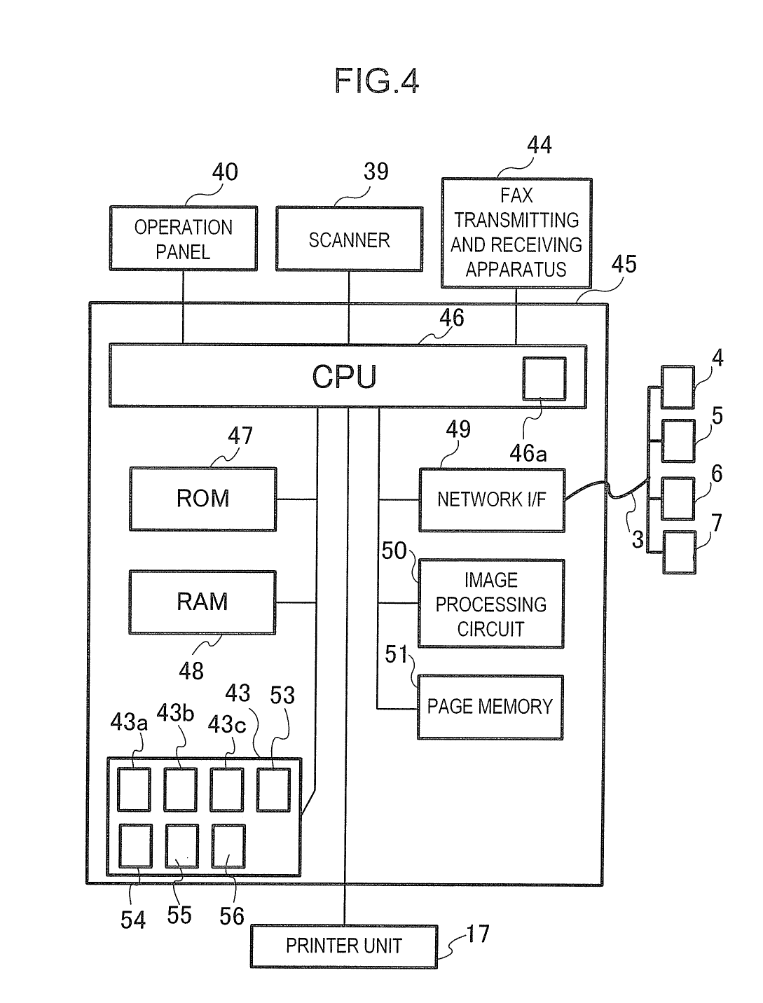

FIG. 4 is a hardware block diagram of a control system for the MFP 2. Reference numerals and signs same as those described above represent the same components. The MFP 2 includes a main control unit 45 that manages the control of the entire MFP 2.

The main control unit 45 includes a CPU (Central Processing Unit) 46, a ROM (Read Only Memory) 47, a RAM (Random Access Memory) 48, a hard disk drive 43, a network interface (network I/F) 49, an image processing circuit 50, and a page memory 51.

The CPU 46 is a processor that manages the control of the entire MFP 2 and has a timer 46a. The ROM 47 stores a control program for controlling the MFP 2. The RAM 48 is a DRAM for work.

As the application programs, the hard disk drive 43 stores programs such as a mailer 43a for transmitting and receiving mails, a web browser 43b, and a viewer 43c for a PDF file.

When the MFP 2 transmits a PDF file from the user terminals 6 and 7 to the web server 10, the mailer 43a transmits a URL (Uniform Resource Locator) of a web page embedded with the PDF file or an image to the approver terminals 4 and 5.

As the utility programs, the hard disk drive 43 stores a waiting queue 53, a job manager 54 (a job managing section), a queue manager 55, and an approval manager 56 (an approval managing section).

The job manager 54 manages queues of a job of the printer unit 17 for printing an image on a medium, a job for transmitting data including image data by mail, a job for distributing the image data through the Internet, and a job for transmitting the image data by facsimile.

The approval manager 56 transmits an approval request for output of material to an address stored by an approval information table 57 (a storing unit) explained later and receives information concerning possibility of output of the material responding to the approval request.

Details concerning the waiting queue 53, the job manager 54, and the like are explained later.

As the temporary data, the hard disk drive 43 stores raster image data generated from PDL data, web page data embedded with PDF file, image data generated by the printer unit 17, transmission and reception facsimile data, and the like.

The network interface 49 is an IC (Integrated Circuit) for transmitting and receiving a packet between the main control unit 45 and the LAN 3.

The image processing circuit 50 is a LSI (Large Scale Integration) that performs correction, compression, expansion, density adjustment, filtering, enlargement/reduction, and the like of PDL data. The page memory 51 is a DRAM that stores image data for one page.

The network interface 49, the operation panel 40, the scanner 39, the facsimile transmitting and receiving apparatus 44, and the printer unit 17 are connected to the CPU 46.

The image processing circuit 50 generates an image from material received through the LAN 3 and stores the image in the page memory 51. The printer unit 17 outputs the material received through the LAN 3 as an image. The mailer 43a transfers the material received through the LAN 3 to the user terminal 7.

The MFP 2 transfers a PDF file received through the LAN 3 to the web server 10. A web page creation program 10a creates a web page.

The facsimile transmitting and receiving apparatus 44 generates a facsimile signal from an image and transmits a signal sequence through the public line 8.

To prevent jobs from being concentrated on the MFP 2, the job manager 54 in the hard disk drive 43 manages requests for print output, mail transfer, web publication, and facsimile transmission as jobs. The job manager 54 manages order of processing of plural jobs using a waiting queue.

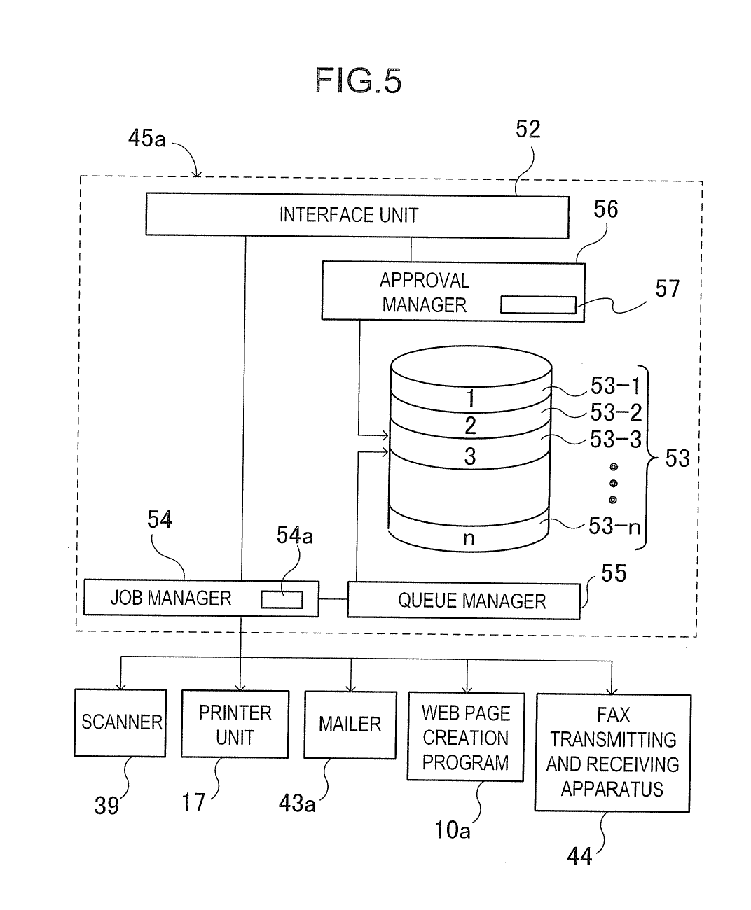

FIG. 5 is a functional block diagram of the control system for the MFP 2. In the figure, an approval function for a print job among all control functions is mainly shown. Reference numerals and signs same as those described above represent the same components.

When a control system 45a receives jobs for printing, mail transfer, web publication, and facsimile transmission of material in the electronic data format, the control system 45a notifies the approver terminals 4 and 5 of a request for approval. The control system 45a executes an approved job.

The control system 45a includes an interface unit 52, the waiting queue 53, the job manager 54, the queue manager 55, and the approval manager 56.

The interface unit 52 receives, from the user terminals 6 and 7, material that should be approved and a job execution request including a job type of a job that should be executed on the material.

The interface unit 52 receives setting of contact destination information of the approver terminals 4 and 5 and the cellular phone 15.

The interface unit 52 receives inquiry about the material type of the material from the user terminals 6 and 7 prior to the reception of the job execution request from the user terminals 6 and 7. The interface unit 52 reads out material type information corresponding to the material type and gives a reply to the user terminals 6 and 7 in response to the inquiry.

The interface unit 52 receives the material from the user terminals 6 and 7, the replied material type information, and a job including a type of the job through the LAN 3.

The interface unit 52 transmits an approval request to the approver terminals 4 and 5 and receives approval or rejection from the approver terminals 4 and 5.

The waiting queue 53 is a spooler storage area or a temporary storage area. The storage area is secured in the hard disk driver 43 or the RAM 48.

The job manager 54 controls execution of a job. The job manager 54 registers the job in the waiting queue 53. The job manger 54 determines whether a job from the interface unit 52 is a job that requires approval.

The queue manager 55 monitors a state of the waiting queue 53. The queue manager 55 searches through the waiting queue 53 periodically, for example, at an interval of 1 second using a timer and monitors whether an executable job is present.

The executable job indicates a print job of an electronic document that does not require approval, a job generated by scanning of the scanner 39, and the like.

The approval manager 56 has the approval information table 57 (a storing unit). The approval information table 57 associates plural material types and mail addresses of approver terminals of approvers of the respective plural material types.

The approval information table 57 stores mail addresses of contact destinations of plural approvers and work flow information having order given to the respective mail addresses. The approval manager 56 acquires approval from the plural approvers according to the order described in the work flow information.

Functions of the interface unit 52 are attained by the CPU 46, the ROM 47, the RAM 48, the hard disk driver 43, and the network interface 49.

All functions of the job manager 54, the queue manager 55, and the approval manager 56 are attained by the CPU 46, the ROM 47, the RAM 48, and the hard disk drive 43.

The CPU 46, the ROM 47, and the RAM 48 configure a control unit. When the approval manager 56 receives approval of output of material, the control unit causes the job manager 54 to execute a job of a job type received by the interface unit 52.

### Explanation of the Operation of the MFP 2

User operation and a job scenario of the operation of the MFP 2 are explained below.

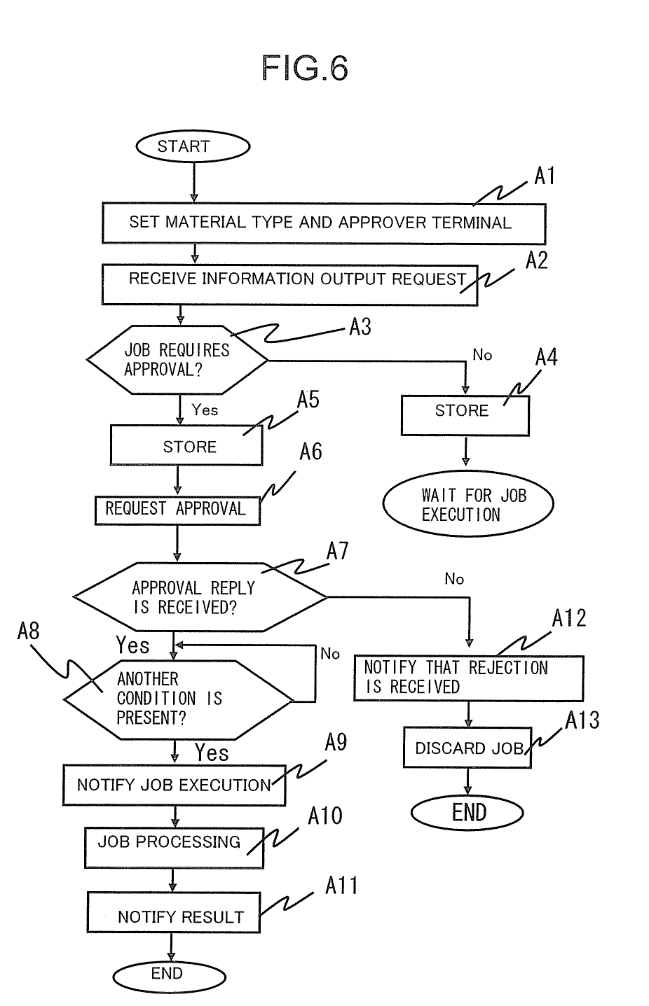

FIG. 6 is a flowchart for explaining a controlling method for the MFP 2.

In Act A1, the MFP 2 sets information necessary for approval. A person who inputs the information is an organization head. The organization head registers the information in the approval manager 56 from the operation panel 40 or the touch screen 41 or the approver terminals 4, 5 or the user terminals 6, 7.

The operation panel 40 or the touch screen 41 displays a dialog box.

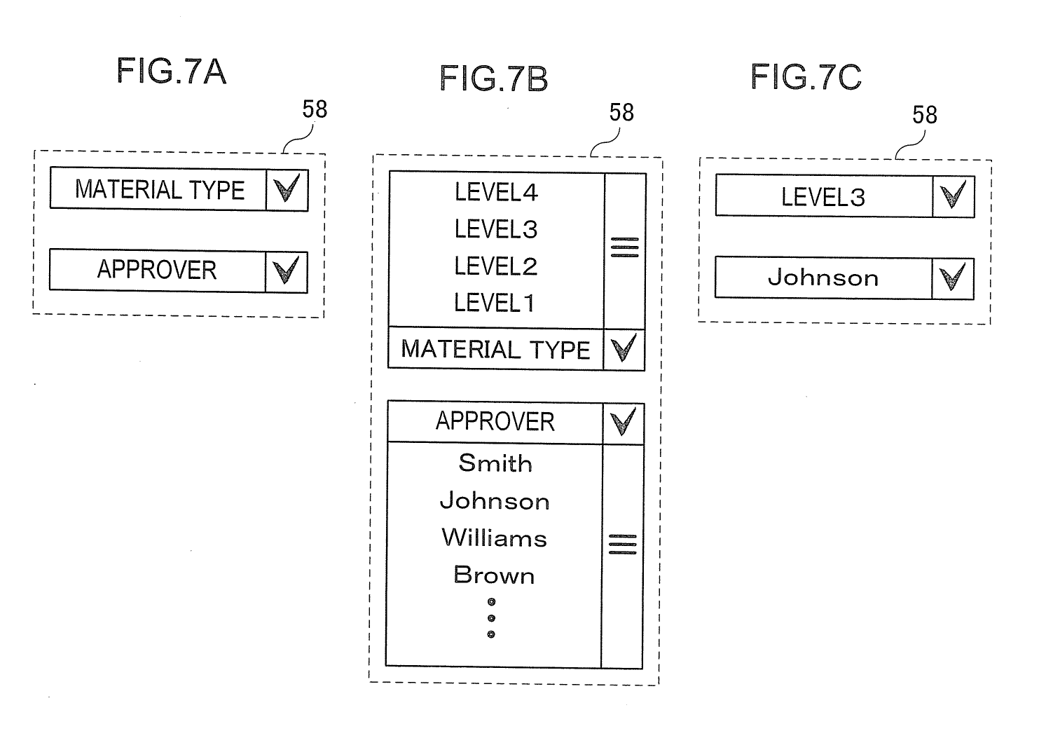

FIGS. 7A to 7C are diagrams of examples of the dialog box. A dialog box 58 has content shown in FIG. 7A. As shown in FIG. 7B, the organization head selects and sets two items using a pull-down menu.

As shown in FIG. 7C, the MFP 2 stores a material type and an approver of the material type in association with each other. For example, when material having the material type of the level 3 is transmitted to the MFP 2, an approval request is notified to a terminal of an approver shown in the figure.

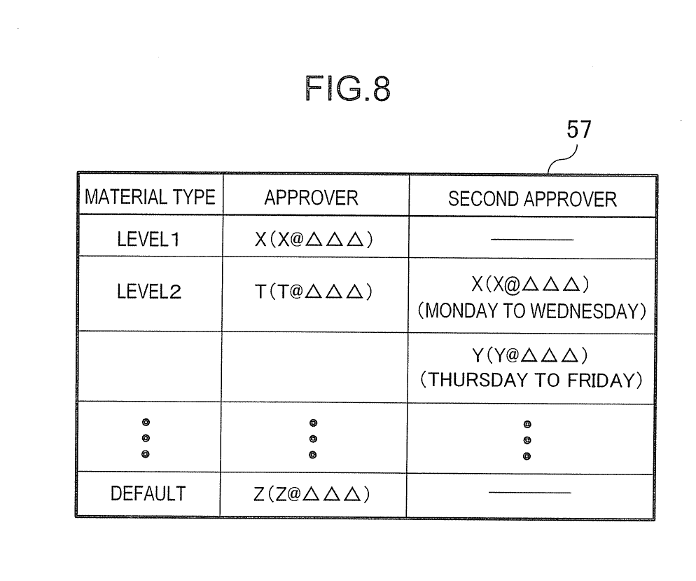

FIG. 8 is a diagram of data structure of the approval information table 57. In the figure, an example of information data in the approval information table 57 after being set by the approval manager 56 is shown in the figure.

For example, as an approver of material with the material type of the level 1, a mail address of an approver X is set in advance.

Concerning material of the level 2, a mail address of the approver T is set. A user may set mail addresses of X and Y as second approvers on the operation panel 40 taking into account that a first approver T is absent.

When approval is executed according to a work flow of work by plural approver terminals, the user sets information concerning the plural approver terminals on the operation panel 40.

When the information concerning the plural approver terminals is set, the user may register mail addresses on the operation panel 40 for each day of the week. Specifically, the approval information table 57 also stores time frames for approval allocated to the respective plural approvers.

The user may set order of approval among the plural approvers on the operation panel 40. The user may set a telephone number of the cellular phone 15 on the operation panel 40.

When approval is necessary for all kinds of information output such as printing, mail transfer, web publication, and facsimile transmission, the user may set a mail address of a terminal of an approver Z as default on the operation panel 40.

In Act A2 in FIG. 6, the MFP 2 receives an information output request from the user terminal 6 or the user terminal 7.

For example, in print output, while the application program of the user terminal 6 opens a file of material, the application program accesses the MFP 2 and inquires the job manager 54 about a material type of material opened on the user terminal 6 side.

When a response of material type information is received from the job manager 54, the application program converts the material into PDL data. The application program transmits a print job including the PDL data and the material type information to the MFP 2.

When the user desires reception of a result of approval or rejection, contact destination information for receiving the result is set on the operation panel 40 in advance.

Operation concerning mail transfer, web publication, and facsimile transmission is substantially the same as the example of the printing. The application program implemented in the user terminal 6 displays, on the display 6b, mail transfer, web publication, or material that should be transmitted by facsimile.

The user selects any one of mail, web, and facsimile with the input device 6c. The application program urges the user to input a mail address, a URL, or a facsimile number. The application program acquires material type information from the MFP 2.

Subsequently, in Act A3 in FIG. 6, the job manager 54 determines, by analyzing a job from the interface unit 52, whether the job is a job that requires approval.

If the job is a print job of a file that does not require security management, a job generated by scan operation, or the like in Act A3, the processing selects a No route.

In Act A4, the job manager 54 stores a job file in the waiting queue 53 and registers an entry address of the job file in the waiting queue 53.

If the job is an output job for material that requires security management in Act A3, the processing selects a Yes route. In Act A5, the job manager 54 stores the job file in the waiting queue 53.

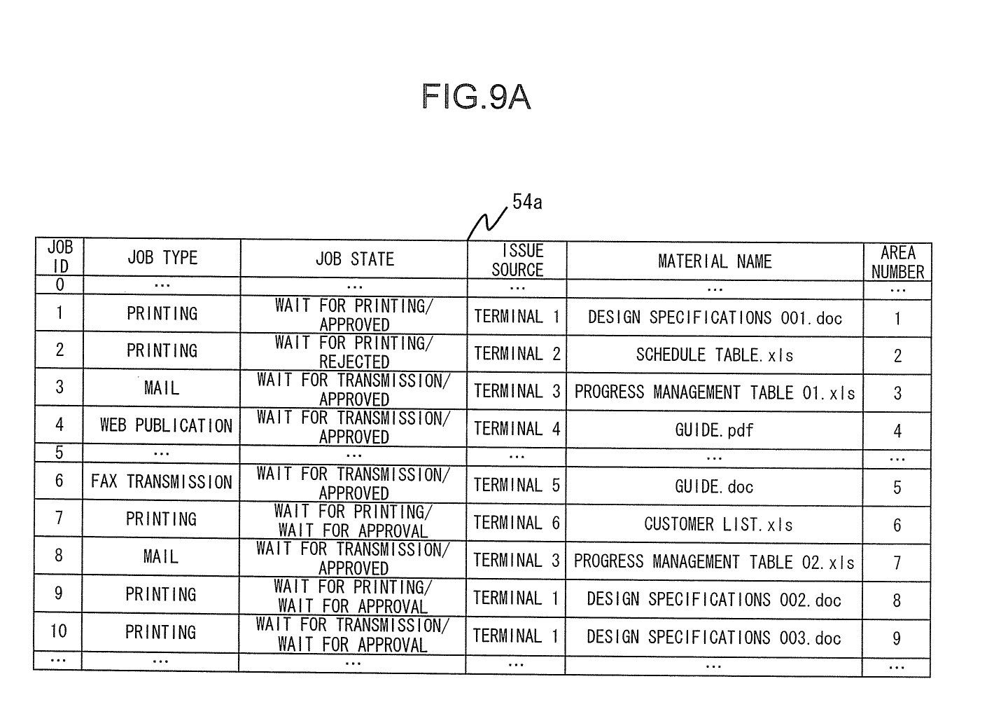

FIG. 9A is a diagram of an example of a job management table 54a. In the figure, output jobs of materials that require security management among all jobs are shown. The job management table 54a is created by the job manager 54.

As shown in FIG. 5, storage areas 53-1 to 53-n of the waiting queue 53 are designated and a received job is stored in the storage area. Area numbers 1 to n are allocated to the storage areas 53-1 to 53-n.

FIG. 9B is a diagram of an example of the waiting queue 53. Reference numerals and signs same as those described above represent the same components. The waiting queue 53 includes an overall header section 59, an application header section 60, and the storage areas 53-1 to 53-n.

The job manager 54 or the queue manager 55 determines, from job states shown in FIGS. 9A and 9B, whether a job is currently executable. In other words, the job states function as flags. The flags distinguish three kinds of states, i.e., approved, rejected, and being approved.

The job manager 54 or the queue manager 55 can rewrite the flag states. When an approval message is received from the approver terminals 4 and 5, information in the waiting queue 53 is changed to “approved”.

In other words, the job manager 54 stores plural jobs with flags for distinguishing approval and rejection attached to the jobs, respectively. The approval manager 56 rewrites the job on the basis of possibility information.

After the job manager 54 registers a queue in Act A5 in FIG. 6, prior to registration of an entry of the job file, in Act A6, the job manager 54 transmits an execution instruction for information output including the material type information to the approval manager 56. The job manager 54 sets a timer.

The approval manager 56 searches through the approval information table 57 and starts approval processing on the basis of the information defined by the approval information table 57. The network interface 49 of the MFP 2 notifies the approver terminal 4 and the like of an approval request message via the LAN 3. In Act A7, the network interface 49 waits for reception of a message.

The approver terminal 4 checks information that should be output.

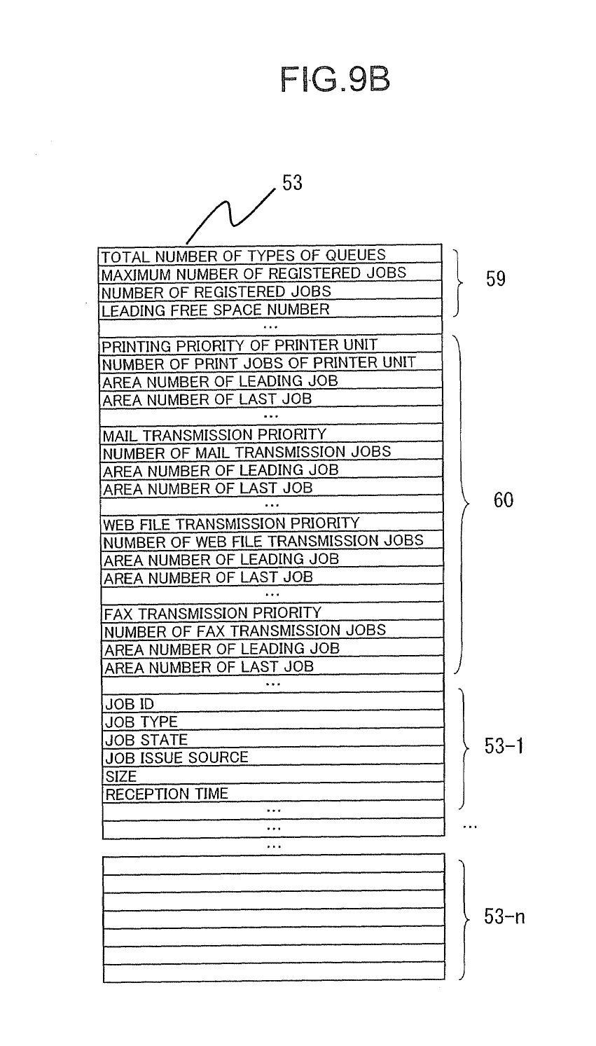

FIG. 10 is a diagram of an example of an approval request screen of the display 4b of the approver terminal 4. The display 4b displays a name of a user who desires output of material, buttons for approval and rejection, and a URL embedded with information that should be approved.

When an icon is clicked, a communication program of the approver terminal 4 and the approval manager 56 start communication. In a state in which information security in a session is secured, the approver terminal 4 displays, on the display 4b, an image in an output state such as a print image of material that should be approved.

When the input device 4c selects an approval button, the approver terminal 4 notifies the MFP 2 of an approval success message. Alternatively, the approver terminal 4 notifies the MFP 2 of a rejection message.

If the MFP 2 receives an approval reply from the approver terminal 4 in Act A7 (FIG. 6), the processing selects a Yes route. In Act A8, the approval manager 56 determines whether another condition is present.

The approval manager 56 determines whether there is a condition that, for example, execution of a job is permitted only after 10 o'clock at night or execution of a job is permitted only in a determined time frame.

If the other condition is not satisfied in Act 8, the approval manager 56 continues not to execute processing concerning the job (a No route).

The approval manager 56 checks whether all the conditions are satisfied. If all the conditions are satisfied, in Act A8, the processing selects the Yes route. In Act A9, the approval manager 56 notifies the job manger 54 of execution of the job.

In Act A10, the job manager 54 notifies the CPU 46 of the execution of the job. The MFP 2 outputs the material.

When the output of the material is completed, in Act A11, the approval manager 56 notifies the approver terminal 4 of a message indicating that the material is output.

If the MFP 2 receives rejection from the approver terminal 4 in Act A7, the processing selects the No route. In Act A12, the approval manager 56 notifies the job manager 54 of a message indicating that the rejection is received.

In Act A13, the job manager 54 discards the rejected job. In this case, the job manager 54 notifies the approver terminal 4 that material restricted from being printed and distributed is not output.

When the MFP 2 does not receive a message from the approver terminal 4 within time determined by a timer value in Act A7, the approval manager 56 performs processing substantially the same as the processing in Acts A12 and A13.

The overall operation of the MFP 2 is explained above. Cooperative operation among three components, i.e., the job manger 54, the queue manager 55, and the approval manager 56, is explained below.

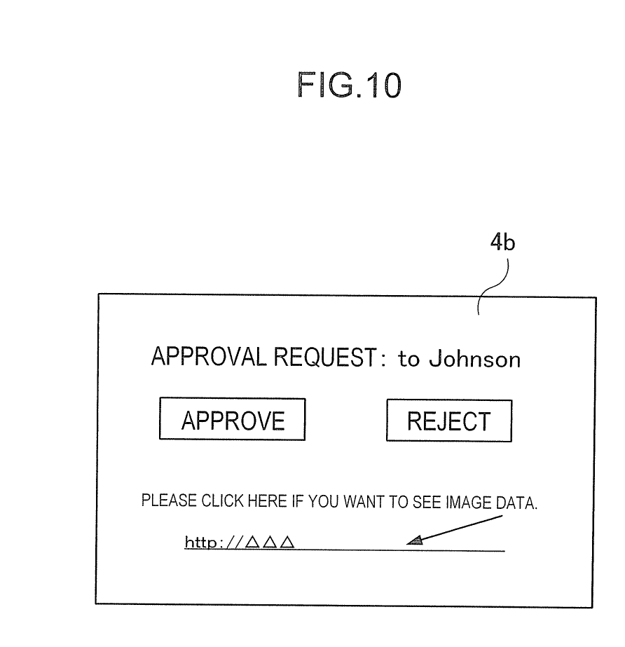

FIG. 11 is a diagram of a collaboration process of the three components and a processing flow. Reference numerals and signs same as those described above represent the same components.

The job manager 54 manages all jobs executed by the MFP 2. The queue manager 55 stores print information. The approval manager 56 manages approval.

In Act B1, with operation of the user on the operation panel 40 as an opportunity, the interface unit 52 actuates the approval manager 56 and sets information necessary for approval. As the opportunity, the user can operate any of the touch screen 41, the approver terminals 4, 5 and the user terminals 6, 7.

In Act B2, the user terminal 6 transmits a job for information output.

The job manager 54 acquires a material type of material from the approval manager 56 and transfers the material type to the user terminal 6. The user terminal 6 attaches material type information to the material and executes operation for some information output. The job manager 54 receives an information output request.

Since the user terminal 6 acquires the material type of the material from the MFP 2, omission of selection can be eliminated and approval can be surely carried out.

All the user terminals 6 and 7 can select any material type. Even if the approval information table 57 of the MFP 2 is updated, the user terminals 6 and 7 can always acquire information concerning a material type in synchronization with updated table content.

In Act B3, the job manager 54 once stores the job in the queue manager 55 as print data.

In Act B4, the queue manager 55 periodically checks whether a job in an executable state is present. When a flag of approval request information is effective, the queue manager 55 notifies the approval manager 56 of an approval request.

In Act B5, the approval manager 56 transmits an approval request message to an approver according to the approval request from the queue manager 55 and approval definition information in the approval information table 57.

In Act B6, the approval manager 56 is requested by the approver terminal 4 to perform print preview.

In Act B7, the approval manager 56 acquires necessary preview information from the page memory 51 or the queue manager 55 and presents a preview of a material that should be approved obtained in this way to the approver terminal 4.

When the approver terminal 4 is present, the approver terminal 4 approves the request. When the approver terminal 4 is absent, the request is left untouched.

In Act B8, when the approver terminal 4 executes approval processing, the approval manager 56 receives a reply of approval.

In Act B9, the approval manager 56 changes a flag state of any one of executable jobs to “approved”. The information output job is allowed to be executed.

In Act B10, the queue manager 55 checks the flag state and notifies the job manager 54 of the flag state of “approved”.

In Act B11, the queue manager 55 periodically checks the waiting queue 53 and executes any one of jobs.

The queue manager 55 searches through a key entry and issues an “approved” job.

In Act B12, the queue manager 55 notifies a contact destination of a requester set in print information of a result.

When the approver terminal 4 rejects the job in Act B9, the approval manager 56 changes a value of the print-executable flag to “rejected”. The information output job is not allowed to be executed. The job with the flag state “rejected” is dropped.

In Act B10, the queue manager 55 notifies the job manager 54 of the change of the state. In Act B11, the queue manager 55 executes possible deletion of a print job file or a queue entry.

The output approval control can be performed in this way. A function that can approve printability of print data spooled by a print instruction rather than specifying a user who can instruct printing is attained.

All user terminals notify approval via the MFP 2. Therefore, even if information concerning the approver terminal is updated, an approval request reaches a contact destination for approval in synchronization with the update.

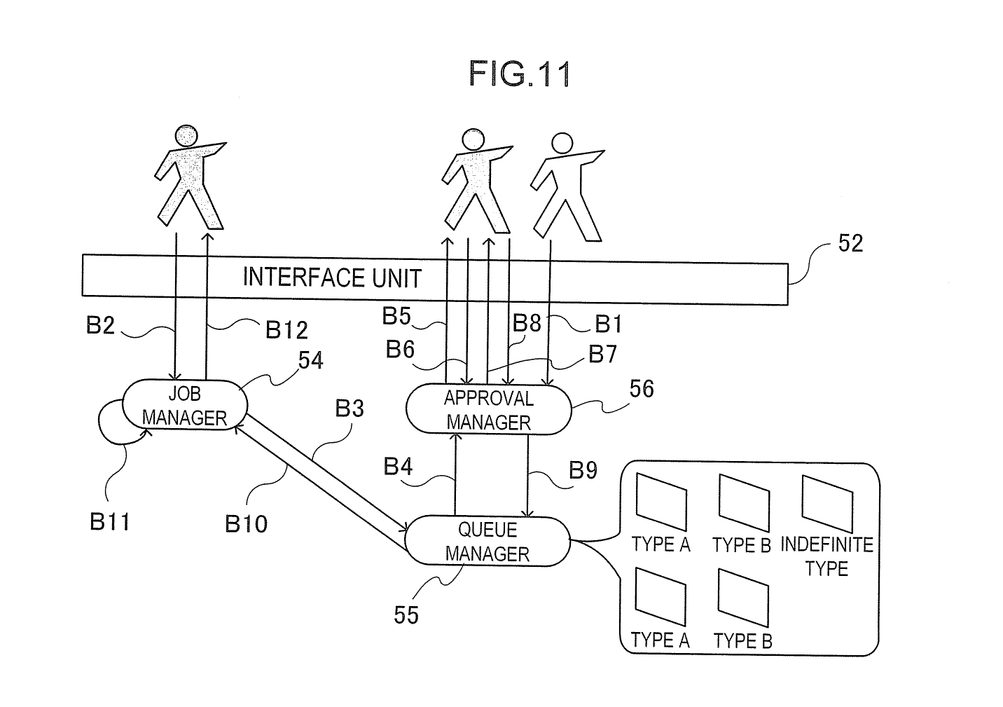

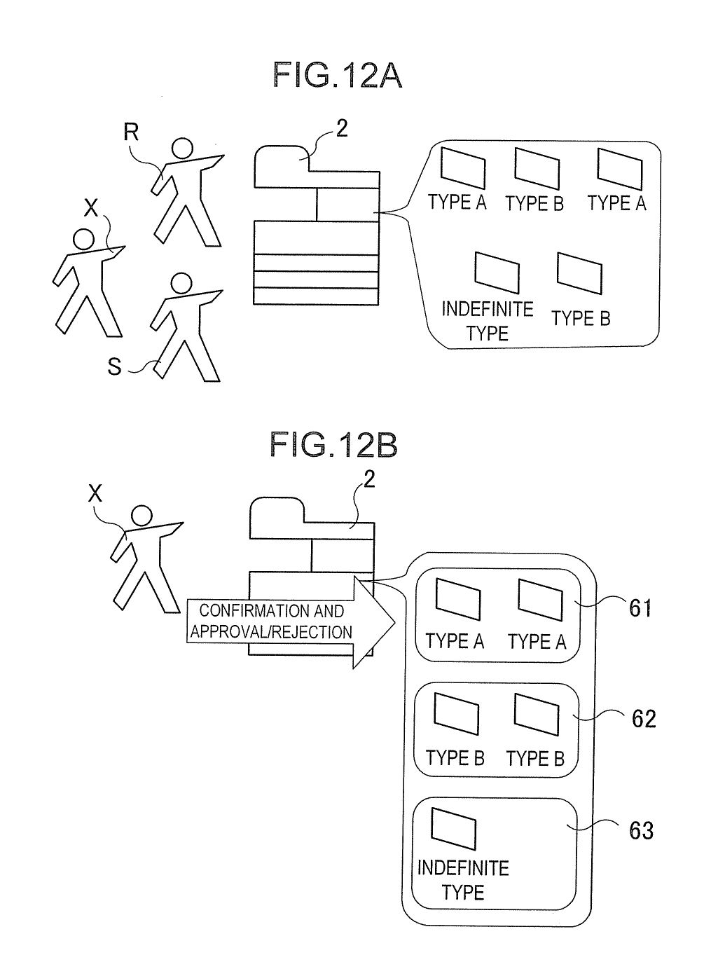

FIG. 12A is a diagram of a situation in which plural user terminals request the MFP 2 to output material. FIG. 12B is a diagram of a situation in which the MFP 2 approves or rejects the output request.

As shown in FIG. 12A, plural kinds of material of material types different from one another are transmitted to the MFP 2 from the approver X and users R and S. Material of an indefinite type, a material type of which is not designated, is also transmitted to the MFP 2.

As shown in FIG. 12B, the MFP 2 can receive confirmation and approval or rejection by the approver X. The MFP 2 can classify the plural kinds of material of the material types different from one another into an approved group 61 and a rejected group 62. Material, a type of which cannot be specified, is classified into a rejected group 63.

In the organization, in some case, an approver is different according to a scope of a job in which the material is distributed.

In this embodiment, since the organization head collectively inputs the approval setting information, a message is automatically notified from the MFP 2 to the contact destination of the approver. The user terminal does not need to find the contact destination and the person does not need to find the approver.

As explained above, concerning material, approval, printing, and the like are executed as one set. Therefore, information security can be improved in the organization.

Concerning important customer information, approval can be set to always pass through a work flow of work by plural people. Therefore, efficiency of information output is improved and, at the same time, information security of content, confidentiality of which should be kept, is protected.

In the embodiment explained above, the electronic document that requires approval is the material of the organization. However, the electronic document can include various document contents.

In the embodiment, a way of setting a routine of approval processing has various degrees of freedom in FIGS. 7A to 7C. Conditions such as a type of a communication terminal, an address number, the number of approvers, date, and a time frame can be changed to carry out the approval processing.

In the embodiment, the material is classified by using the material type. However, hierarchies of the classification of the material may be increased. The material is classified by using a material category in addition to the material type. When the number of types of the material type is large, the MFP 2 stores definition information such that plural kinds of the material type belong to one type of the material category.

The approver having the approval authority is registered in the approval information table 57 on the MFP 2 side.

The approval information table 57 stores category information of plural material categories, one or more types of material type information classified for each of the material categories, contact destination addresses and telephone numbers of approver terminals in the respective material categories, and the like in association with one another.

Consequently, when the job manager 54 receives a print job for material attached with a material type, the job manager 54 searches for an approver terminal in a material category to which the material type belongs and notifies the approver terminal of an approval request. Subsequent processing is substantially the same as the example explained above.

A way of defining a material type and a material category can be variously changed. Superiority of the present invention over an invention that only changes and carries out the way of defining a material type and a material category is not spoiled at all.

FIGS. 9A and 9B referred to in the embodiment are examples for attaining the waiting queue 53 and the flags. Information contents of the job management table 54a and the waiting queue 53 can be variously changed.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a job managing unit configured to manage queues of a job of an image forming unit for printing an image on a medium, a job for transmitting data including image data by mail, a job for distributing the image data through the Internet, and a job for transmitting the image data using a facsimile apparatus;
an interface unit configured to receive, from a communication apparatus connected to a network, a job execution request including an electronic document that should be approved and a job type of any one of the jobs executed on the electronic document;
a storing unit configured to store document type information for identifying a type of the electronic document received by the interface unit and a contact destination of an approver for the electronic document in association with each other;
an approval managing unit configured to transmit an approval request for output of the electronic document to the contact destination stored by the storing unit and receive a determination result concerning possibility of output responding to the approval request; and
a control unit configured to cause, when the determination result received by the approval managing unit is affirmative, the job managing unit to execute the job of the job execution request received by the interface unit.

2. The apparatus of claim 1, wherein
the job managing unit stores plural jobs with flags for distinguishing approval and rejection attached to the respective plural jobs, and
the approval managing unit rewrites the flags on the basis of information concerning the propriety.

3. The apparatus of claim 1, wherein, when an inquiry about a document type of the electronic document that should be approved is received from the communication apparatus prior to the reception of the job execution request from the communication apparatus, the interface unit reads out the document type information corresponding to the document type from the storing unit and transmits the document type information to the communication apparatus as a reply.

4. The apparatus of claim 3, wherein, when the job execution request including the document type information transmitted to the communication apparatus by the interface unit as the reply is received from the communication apparatus, the approval managing unit transmits the approval request to the contact destination.

5. The apparatus of claim 1, wherein
the storing unit stores contact destinations of a plurality of the approvers and work flow information having order given to each of the contact destinations, and
the approval managing unit acquires approval from the plurality of the approvers with reference to the order of the work flow information.

6. The apparatus of claim 1, wherein the storing unit stores document category information of plural document categories to which a document type of the electronic document that should be approved belongs, one or more types of the document type information classified to each of the document categories, and contact destinations of approvers of the document categories in association with one another.

7. The apparatus of claim 5, wherein the storing unit stores time frames of approval respectively allocated to the plurality of the approvers.

8. The apparatus of claim 1, wherein the storing unit stores another contact destination for notifying a result of approval or rejection of output of the electronic document.

9. The apparatus of claim 1, wherein the approval managing unit transmits a preview of the electronic document that should be approved to the contact destination.

10. The apparatus of claim 1, wherein, when the determination result is negative, the control unit causes the job managing unit to discard the job of the job execution request received by the interface unit.

11. A controlling method for an image forming apparatus comprising:
a storing unit setting and storing document type information for identifying a type of an electronic document that should be approved and a contact destination of an approver of the electronic document in association with each other;
an interface unit, which transmits and receives information to and from a communication apparatus connected to a network, receiving a job execution request including the electronic document and a job type of any one of jobs executed on the electronic document from the communication apparatus;
an approval managing unit transmitting an approval request for output of the electronic document to the contact destination stored by the storing unit and receiving a determination result concerning possibility of output responding to the approval request;
a control unit notifying, when the determination result received by the approval managing unit is affirmative, a job managing unit, which manages a job queue, of the job type of the job execution request received by the interface unit; and
the job managing unit executing the job of the notified job type among a job of an image forming unit for printing an image on a medium, a job for transmitting data including image data by mail, a job for distributing the image data through the Internet, and a job for transmitting the image data using a facsimile apparatus.

12. The method of claim 11, wherein
the job enqueued by the job managing unit has a flag for distinguishing approval and rejection in each of plural jobs, and
the management by the approval managing unit rewrites the flag on the basis of information concerning the propriety.

13. The method of claim 11, wherein the interface unit receives an inquiry about a document type of the electronic document that should be approved from the communication apparatus prior to the reception of the job execution request from the communication apparatus, reads out the document type information corresponding to the document type from the storing unit, and transmits the document type information to the communication apparatus as a reply.

14. The method of claim 13, wherein the transmission of the approval request to the contact destination by the approval managing unit is performed on receiving, from the communication apparatus, the job execution request including the document type information transmitted to the communication apparatus as the reply by the interface unit.

15. The method of claim 11, wherein
work flow information stored by the storing unit has contact destinations of a plurality of the approvers and order given to each of the contact destinations, and
acquisition of approval from the plurality of the approvers by the approval managing unit refers to the order of the work flow information.

16. The method of claim 11, wherein information stored by the storing unit associates document category information of plural document categories to which a document type of the electronic document that should be approved belongs, one or more types of the document type information classified to each of the document categories, and contact destinations of approvers of the document categories.

17. The method of claim 15, wherein information stored by the storing unit is a time frame of approval allocated to each of the plurality of the approvers.

18. The method of claim 11, wherein information stored by the storing unit is another contact destination for notifying a result of approval or rejection of output of the electronic document.

19. The method of claim 11, wherein information transmitted to the contact destination by the approval managing unit is a preview of the electronic document that should be approved.

20. The method of claim 11, wherein, when the determination result is negative, the control unit causes the job managing unit to discard the job of the job execution request received by the interface unit.
